(19) United States
(12) Patent Application Publication
(10) Pub. No.: US 2014/0251950 A1
(43) Pub. Date: Sep. 11, 2014

(54) POLISHING COMPOSITION

(71) Applicants: Yukinobu Yoshizki, Kiyosu-shi (JP); Yoshihiro Izawa, Kiyosu-shi (JP)

(72) Inventors: Yukinobu Yoshizki, Kiyosu-shi (JP); Yoshihiro Izawa, Kiyosu-shi (JP)

(73) Assignee: FUJIMI INCORPORATED, Kiyosu-shi, Aichi (JP)

(21) Appl. No.: 14/346,921

(22) PCT Filed: Sep. 28, 2012
(86) PCT No.: PCT/JP2012/075052

§ 371 Date: Mar. 24, 2014

(30) Foreign Application Priority Data
Sep. 30, 2011 (JP) 2011-218723
Feb. 9, 2012 (JP) 2012-026290

(51) Int. Cl. C09G 1/02

(52) U.S. Cl. CPC C09G 1/02
USPC 216/38; 423/352; 252/79.1

(57) ABSTRACT

A polishing composition of the present invention is used for polishing an object containing a phase-change alloy and is characterized by containing ammonium ions (NH₄⁺). The polishing composition may further contain abrasive grains, such as colloidal silica.

### TECHNICAL FIELD

The present invention relates to a polishing composition suitable for polishing an object containing a phase-change alloy.

### BACKGROUND ART

A phase-change material (PCM), which can be electrically switched between an insulative amorphous phase and a conductive crystalline phase, for an electronic memory application is utilized for a PRAM (phase-change random access memory) device (also known as an ovonic memory device or a PCRAM device). Examples of typical phase-change materials suitable for this application include a combination of an element of VIE group (chalcogenide, for example, Te or Po) and VB group (for example, Sb) of the periodic table and one or more metal elements such as In, Ge, Ga, Sn, and Ag. A particularly useful phase-change material is a germanium (Ge)-antimony (Sb)-tellurium (Te) alloy (GST alloy). The physical conditions of these materials may reversibly change depending on heating/cooling rate, temperature, and time. Examples of other useful phase-change alloys include indium antimonite (InSb). The memory information in the PRAM device is stored with minimizing loss by the conduction characteristics of different physical phases or states.

Chemical mechanical polishing (CMP) is known as a method for polishing a metal-containing surface of a semiconductor substrate (for example, integrated circuit). The polishing composition used in CMP typically contains abrasive grains, an oxidizing agent, and a complexing agent to effectively polish the surface by the etching action.

CMP can be utilized for manufacturing a memory device that uses a phase-change material. However, unlike a conventional metal layer composed of a single component such as copper (Cu) and tungsten (W), a plurality of elements such as sulfur (S), cerium (Ce), germanium (Ge), antimony (Sb), tellurium (Te), silver (Ag), indium (In), tin (Sn), and gallium (Ga) are mixed in a phase-change material at a specific ratio that allows reversible phase-change between a crystalline phase and an amorphous phase. For this reason, the physical properties of many phase-change materials (for example, GST) are different from the physical properties of conventional metal layer materials, for example, in that they are softer than other materials used in a PCM chip. Therefore, it is difficult to apply the conventional polishing composition for polishing metal-containing surfaces as it is to the polishing of a phase-change material.

In such a situation, various investigations have been performed on a polishing composition suitable for polishing an object containing a phase-change alloy. For example, Patent Document 1 discloses a polishing composition for polishing an object containing a phase-change alloy, the composition containing abrasive grains and a nitrogen compound. Further, Patent Document 2 discloses a polishing composition for polishing an object containing a phase-change alloy, the composition containing abrasive grains and iron ions or an iron chelate complex. However, the polishing compositions disclosed in these documents do not yet have sufficient performance for polishing an object containing a phase-change alloy, and improvement in the performance is desired.

### PRIOR ART DOCUMENTS

### Patent Document 1: Japanese Laid-Open Patent Publication No. 2009-016021

### Patent Document 2: Japanese Laid-Open Patent Publication No. 2009-016829

### SUMMARY OF THE INVENTION

### Problems that the Invention is to Solve

Accordingly, it is an objective of the present invention to provide a polishing composition that can be suitably used for polishing an object containing a phase-change alloy. Particularly, it is an objective of the present invention to provide a polishing composition having an increased polishing rate of a phase-change alloy, without depending on an oxidizing agent and a complexing agent that are contained in conventional typical polishing compositions for polishing a metal-containing surface.

### Means for Solving the Problems

As a result of intensive and extensive studies, the inventors of the present invention have found that a polishing composition containing ammonium ions enables polishing an object containing a phase-change alloy at a high polishing rate.

Specifically, in order to achieve the foregoing objective and in accordance with, one aspect of the present invention, a polishing composition to be used for polishing an object containing a phase-change alloy, such as a GST alloy, is provided that contains ammonium ions (NH₄⁺).

In one embodiment, as the ammonium ions, ammonium hydroxide is incorporated into the polishing composition.

In another embodiment, as the ammonium ions, one or more ammonium salts selected from the group consisting of an ammonium salt of an organic acid and an ammonium salt of an inorganic acid are incorporated into the polishing composition.

The polishing composition may further contain abrasive grains.

The abrasive grains are preferably colloidal silica.

Another aspect of the present invention provides a polishing method for polishing a surface of an object containing a phase-change alloy with the polishing composition according to the above aspect.

Yet another aspect of the present invention provides a method for producing a phase-change device that includes polishing a surface of an object containing a phase-change alloy with the polishing composition according to the above aspect.

### Effects of the Invention

The present invention provides a polishing composition that can be suitably used for polishing an object containing a phase-change alloy, particularly a polishing composition having an increased polishing rate of a phase-change alloy.

### MODES FOR CARRYING OUT THE INVENTION

Hereinafter, one embodiment of the present invention will be described.

A polishing composition according to the present embodiment is used for polishing an object containing a phase-change alloy, specifically polishing a surface of an object containing a phase change-alloy to produce a phase-change device. The phase-change alloy is utilized as a material that can be electrically switched between an insulative amorphous phase and a conductive crystalline phase for an electronic memory application in a PRAM (phase-change random access memory) device (also known as an ovonic memory device or a PCRAM device). Examples of the phase-change alloy suitable for this application include a combination of an element of VIB group (chalcogenide, for example, Te or Po) and VS group (for example, Sb) of the periodic table and one or more metal elements such as In, Ge, Ga, Sn, and Ag. A particularly useful phase-change material is a germanium (Ge)-antimony (Sb)-tellurium (Te) alloy (GST alloy).

The polishing composition of the present embodiment contains ammonium ions. In the case where an object is polished with a conventional typical polishing composition used for polishing a metal-containing surface, a metal of the object is oxidized by the action of an oxidizing agent contained in the polishing composition to produce a metal oxide, and the metal oxide is dissolved by the action of a complexing agent also contained in the polishing composition, thereby to perform metal polishing. On the other hand, when a phase-change alloy is polished with the polishing composition of the present embodiment, ammonium ions contained in the polishing composition is complexed with and bound to the surface of the phase-change alloy to form an insoluble brittle film on the surface of the phase-change alloy. The brittle film is easily removed by mechanical polishing action, which is supposed the reason why the polishing composition of the present embodiment enables polishing the phase-change alloy at a high polishing rate.

As the ammonium ions, aqueous ammonia (ammonium hydroxide) may be incorporated into the polishing composition, or ammonia gas may be incorporated and dissolved into the polishing composition. Alternatively, as the ammonium ions, a salt of an acid and ammonia may be incorporated into the polishing composition.

When a salt of an acid and ammonia is used as an ammonium ion source, the type of the acid is not particularly limited. However, it is desirable to use a salt that easily dissociates ammonium ions in the polishing composition. Examples of the acid that forms a salt satisfying such conditions with ammonia include: inorganic acids such as hydrochloric acid, nitric acid, phosphoric acid, sulfuric acid, and boric acid; and organic acids such as fatty acids including formic acid, acetic acid, and propionic acid, aromatic carboxylic acids including benzoic acid and phthalic acid, citric acid, oxalic acid, tartaric acid, malic acid, maleic acid, fumaric acid, succinic acid, organic sulfonic acids, and organic phosphonic acids. The ammonium salt may be used alone or in combination of two or more. In any case, it is desirable that the ammonium salt can be present in a form of ammonium ions as much as possible in the polishing composition without forming a salt.

The upper limit of the content of ammonium ions in the polishing composition is preferably 5 mol/L, more preferably 3 mol/L, further preferably 1 mol/L, in terms of ammonia. As the content of ammonium ions decreases, the production cost of the polishing composition is reduced, and the safety of the polishing composition increases to thereby improve the handleability thereof.

The lower limit of the content of ammonium ions in the polishing composition is preferably 0.001 mol/L, more preferably 0.01 mol/L, further preferably 0.1 mol/L, in terms of ammonia. The polishing rate of the phase-change alloy by the polishing composition increases as the content of ammonium ions increases.

### (pH of Polishing Composition and pH Adjuster)

The upper limit of the pH of the polishing composition is not particularly limited, but it is preferably 12, more preferably 10. The handleability of the polishing composition is improved as the pH thereof decreases.

The lower limit of the pH of the polishing composition is also not particularly limited, but it is preferably 1, more preferably 3. When abrasive grains are added to the polishing composition, the dispersibility of the abrasive grains in the polishing composition is improved as the pH of the polishing composition increases.

A pH adjuster may be used for adjusting the pH of the polishing composition to a desired value. The pH adjuster to be used may be any of acids and alkalis, and may be any of inorganic compounds and organic compounds.

### (Abrasive Grains)

The polishing composition may contain abrasive grains. The abrasive grains may be any of inorganic particles, organic particles, and organic-inorganic composite particles. Specific examples of the inorganic particles include particles composed of metal oxides, such as silica, alumina, ceria, and titania, silicon nitride particles, silicon carbide particles, and boron nitride particles. Specific examples of the organic particles include poly(methyl methacrylate) (PMMA) particles. Among them, silica particles are preferred, and particularly preferred is colloidal silica.

The abrasive grains may be surface-modified. Since common colloidal silica has a value of zeta potential of close to zero under acidic conditions, the silica particles do not electrically repel each other to easily cause aggregation under acidic conditions. On the other hand, abrasive grains which are surface-modified so that the zeta potential may have a relatively large positive or negative value even under acidic conditions strongly repel each other even under acidic conditions and are satisfactorily dispersed. As a result, the storage stability of the polishing composition is improved. Such surface-modified abrasive grains can be obtained, for example, by mixing a metal such as aluminum, titanium, and zirconium or an oxide thereof with abrasive grains to allow the surface of the abrasive grains to be doped with the metal or oxide thereof.

Alternatively, the surface-modified abrasive grains in the polishing composition may be silica on which an organic acid is immobilized. Especially, colloidal silica on which an organic acid is immobilized is preferred. The immobilization of an organic acid on colloidal silica is carried out by chemically binding a functional group of the organic acid to the surface of the colloidal silica. The immobilization of an organic acid on colloidal silica is not achieved only by allowing the colloidal silica and the organic acid to coexist. The immobilization of sulfonic acid, one of organic acids, on colloidal silica can be carried out, for example, by a method described in “Sulfonic acid-functionalized silica through quantitative oxidation of thiol groups”, Chem. Commun. 246-247 (2003). Specifically, colloidal silica in which sulfonic acid is immobilized on the surface thereof can be obtained by coupling a silane coupling agent having a thiol group such as 3-mercaptopropyltrimethoxysilane to colloidal silica and then oxidizing the thiol group with hydrogen peroxide. Alternatively, the immobilization of carboxylic acid on colloidal silica can be carried out, for example, by a method described in “Novel Silane Coupling Agents Containing a Photolabile 2-Nitrobenzyl Ester for Introduction of a Carboxy Group on the Surface of Silica Gel”, Chemistry Letters, 3, 228-229 (2000). Specifically, colloidal silica in which carboxylic acid is immobilized on the surface thereof can be obtained by coupling a silane coupling agent containing a photoreactive 2-nitrobenzyl ester to colloidal silica followed by light irradiation.

The content of the abrasive grains in the polishing composition is preferably 0.1% by mass or more, more preferably 0.5% by mass or more, further preferably 1% by mass or more. As the content of the abrasive grains increases, there is an advantage of increasing the polishing rate of the phase-change alloy by the polishing composition.

Further, the content of the abrasive grains in the polishing composition is preferably 20% by mass or less, more preferably 15% by mass or less, further preferably 10% by mass or less. As the content of the abrasive grains decreases, the material cost of the polishing composition is reduced, and the aggregation of the abrasive grains is less likely to occur. Further, a polished surface with few surface defects is easily obtained by polishing the phase-change alloy with the polishing composition.

The average primary particle size of the abrasive grains is preferably 5 nm or more, more preferably 7 nm or more, further preferably 10 nm or more. The polishing rate of the phase-change alloy by the polishing composition increases as the average primary particle size of the abrasive grains increases. The value of the average primary particle size of the abrasive grains can be calculated, for example, based on the specific surface area of the abrasive grains measured by the BET method.

Further, the average primary particle size of the abrasive grains is preferably 100 nm or less, more preferably 90 nm or less, further preferably 80 nm or less. As the average primary particle size of the abrasive grains decreases, a polished surface with few surface defects is easily obtained by polishing the phase-change alloy with the polishing composition.

The average secondary particle size of the abrasive grains is preferably 150 nm or less, more preferably 120 nm or less, further preferably 100 nm or less. The value of the average secondary particle size of the abrasive grains can be measured, for example, by a laser light scattering method.

The average degree of association of the abrasive grains, which is a calculated value obtained by dividing the value of the average secondary particle size of the abrasive grains by the value of the average primary particle size thereof, is preferably 1.2 or more, more preferably 1.5 or more. The polishing rate of the phase-change alloy by the polishing composition increases as the average degree of association of the abrasive grains increases.

The average degree of association of the abrasive grains is preferably 4 or less, more preferably 3 or less, further preferably 2 or less. As the average degree of association of the abrasive grains decreases, a polished surface with few surface defects is easily obtained by polishing the phase-change alloy with the polishing composition.

### (Oxidizing Agent)

The polishing composition may contain an oxidizing agent. The oxidizing agent has an action of oxidizing the surface of an object to be polished, and is estimated to be effective in helping the ammonium ions contained in the polishing composition form a complex with the phase-change alloy surface to form an insoluble brittle film. As a result, there is an effect of increasing the polishing rate of the phase-change alloy by the polishing composition when the oxidizing agent is added to the polishing composition. However, when the phase-change alloy is polished with a conventional typical polishing composition to be used for polishing a metal-containing surface, the phase-change alloy tends to be excessively polished. This is probably because the characteristics of the phase-change alloy are different from the characteristics of a metallic material such as copper commonly used in a semiconductor device.

The upper limit of the content of the oxidizing agent in the polishing composition is preferably 10% by mass, more preferably 5% by mass. As the content of the oxidizing agent decreases, excessive oxidation of the phase-change alloy by the oxidizing agent is harder to occur. Therefore, excessive polishing of the phase-change alloy is suppressed.

The lower limit of the content of the oxidizing agent in the polishing composition is preferably 0.1% by mass, more preferably 0.3% by mass. An increase in the polishing rate of the phase-change alloy is promoted as the content of the oxidizing agent increases.

Examples of the oxidizing agent that can be used include peroxides. Specific examples of the peroxides include hydrogen peroxide, barium peroxide, peracetic acid, percarbonates, urea peroxide, performic acid, perbenzoic acid, perphthalic acid, peroxodisulfuric acid, peroxophosphoric acid, peroxosulfuric acid, peroxoboric acid, perchloric acid, and persulfates, such as sodium persulfate, potassium persulfate, and ammonium persulfate. In addition, an organic oxidant, ozone water, a silver (II) salt, an iron (III) salt, permanganic acid, chromic acid, dichromic acid, hypochlorous acid, hypobromous acid, hypoiodous acid, chloric acid, chlorous acid, bromic acid, iodic acid, periodic acid, sulfuric acid, nitric acid, nitrous acid, citric acid, dichloroisocyanuric acid, and a salt of these acids can also be used as the oxidizing agent. Among them, persulfates and hydrogen peroxide are preferred from the point of view of the polishing rate, and hydrogen peroxide is particularly preferred from the point of view of the stability in an aqueous solution and the environmental load.

### (Complexing Agent)

The polishing composition may contain a complexing agent. The complexing agent has the effect of chemically etching the surface of the phase-change alloy and thus increasing the polishing rate of the phase-change alloy by the polishing composition. However, when the phase-change alloy is polished with a conventional typical polishing composition to be used for polishing a metal-containing surface, excessive etching of the phase-change alloy may occur, and as a result, the phase-change alloy tends to be excessively polished. This is probably because the characteristics of the phase-change alloy are different from the characteristics of a metallic material such as copper commonly used in a semiconductor device.

The upper limit of the content of the complexing agent in the polishing composition is preferably 10% by mass, more preferably 1% by mass. As the content of the complexing agent decreases, excessive etching of the phase-change alloy by the complexing agent is harder to occur. Therefore, excessive polishing of the phase-change alloy is suppressed.

The lower limit of the content of the complexing agent in the polishing composition is preferably 0.01% by mass, more preferably 0.1% by mass. Since the etching effect of the complexing agent on the phase-change alloy increases as the content of the complexing agent increases, an increase in the polishing rate of the phase-change alloy by the polishing composition is promoted.

Examples of the complexing agent that can be used include inorganic acids, organic acids, and amino acids. Specific examples of the inorganic acids include sulfuric acid, nitric acid, boric acid, carbonic acid, hypophosphorous acid, phosphorous acid, and phosphoric acid. Specific examples of the organic acids include formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, and lactic acid. Organic sulfonic acids, such as methanesulfonic acid, ethanesulfonic acid, and isethionic acid, can also be used. A salt such as an alkali metal salt of an inorganic acid or an organic acid may be used instead of an inorganic acid or an organic acid or in combination with an inorganic acid or an organic acid. Specific examples of the amino acids include glycine, α-alanine, β-alanine, N-methylglycine, N,N-dimethylglycine, 2-aminobutyric acid, norvaline, valine, leucine, norleucine, isoleucine, phenylalanine, praline, sarcosine, ornithine, lysine, taurine, serine, threonine, homoserine, tyrosine, vicine, tricine, 3,5-diiodo-tyrosine, β-(3,4-dihydroxyphenyl)-alanine, thyroxine, 4-hydroxy-proline, cysteine, methionine, ethionine, lanthionine, cystathionine, cystine, cysteic acid, aspartic acid, glutamic acid, S-(carboxymethyl)-cysteine, 4-aminobutyric acid, asparagine, glutamine, azaserine, arginine, canavanine, citrulline, δ-hydroxy-lysine, creatine, histidine, 1-methyl-histidine, 3-methyl-histidine, and tryptophan. Among them, glycine, alanine, malic acid, tartaric acid, citric acid, glycolic acid, and isethionic acid, or salts thereof are preferred as a complexing agent from the point of view of increasing the polishing rate.

### (Metal Corrosion Inhibitor)

The polishing composition may contain a metal corrosion inhibitor. When the metal corrosion inhibitor is added to the polishing composition, there is an effect of further decreasing the occurrence of surface defects such as dishing in the phase-change alloy after polishing with the polishing composition. In addition, when the polishing composition contains the oxidizing agent and/or the complexing agent, the metal corrosion inhibitor relieves the oxidation of the phase-change alloy surface by the oxidizing agent and also reacts with metal ions, which are produced by the oxidation of a metal of the phase-change alloy surface by the oxidizing agent, to produce an insoluble complex. As a result, the etching of the phase-change alloy by the complexing agent is suppressed, and excessive polishing of the phase-change alloy is suppressed.

Although the type of the metal corrosion inhibitor that can be used is not particularly limited, a heterocyclic compound is preferred. The number of members in heterocyclic rings in the heterocyclic compound is not particularly limited. The heterocyclic compound may be a monocyclic compound or a polycyclic compound having a condensed ring.

Specific examples of the heterocyclic compound as a metal corrosion inhibitor include nitrogen-containing heterocyclic compounds, such as pyrrole compounds, pyrazole compounds, imidazole compounds, triazole compounds, tetrazole compounds, pyridine compounds, pyrazine compounds, pyridazine compounds, pyrimidine compounds, indolizine compounds, indole compounds, isoindole compounds, indazole compounds, purine compounds, quinolizine compounds, quinoline compounds, isoquinoline compounds, naphthyridine compounds, phthalazine compounds, quinoxaline compounds, quinazoline compounds, cinnoline compounds, Buterizine compounds, thiazole compounds, isothiazole compounds, oxazole compounds, isoxazole compounds, and furazan compounds. Specific examples of the pyrazole compounds include 1H-pyrazole, 4-nitro-3-pyrazole carboxylic acid, and 3,5-pyrazole carboxylic acid. Specific examples of the imidazole compounds include imidazole, 1-methylimidazole, 2-methylimidazole, 4-methylimidazole, 1,2-dimethylpyrazol, 2-ethyl-4-methylimidazole, 2-isopropylimidazole, benzimidazole, 5,6-dimethylbenzimidazole, 2-aminobenzimidazole, 2-chlorobenzimidazole, and 2-methylbenzimidazole. Specific examples of the triazole compounds include 1,2,3-triazole, 1,2,4-triazole, 1-methyl-1,2,4-triazole, methyl-1H-1,2,4-triazole-3-carboxylate, 1,2,4-triazole-3-carboxylic acid, 1,2,4-triazole-3-methyl carboxylate, 3-amino-1H-1,2,4-triazole, 3-amino-5-benzyl-4H-1,2,4-triazole, 3-amino-5-methyl-4H-1,2,4-triazole, 3-nitro-1,2,4-triazole, 3-bromo-5-nitro-1,2,4-triazole, 4-(1,2,4-triazol-1-yl)phenol, 4-amino-1,2,4-triazole, 4-amino-3,5-dipropyl-4H-1,2,4-triazole, 4-amino-3,5-dimethyl-4H-1,2,4-triazole, 4-amino-3,5-diheptyl-4H-1,2,4-triazole, 5-methyl-1,2,4-triazole-3,4-diamine, 1-hydroxybenzotriazole, 1-aminobenzotriazole, 1-carboxybenzotriazole, 5-chloro-1H-benzotriazole, 5-nitro-1H-benzotriazole, 5-carboxy-1H-benzotriazole, 5,6-dimethyl-1H-benzotriazole, and 1-(1″,2′-dicarboxy ethyl)benzotriazole. Specific examples of the tetrazole compounds include 1H-tetrazole, 5-methyltetrazole, 5-aminotetrazole, and 5-phenyltetrazole. Specific examples of the indole compounds include 1H-indole, 1-methyl-1H-indole, 2-methyl-1H-indole, 3-methyl-1H-indole, 4-methyl-1H-indole, 5-methyl-1H-indole, 6-methyl-1H-indole, and 7-methyl-1H-indole. Specific examples of the indazole compounds include 1H-indazole and 5-amino-1H-indazole. Since these heterocyclic compounds have high chemical or physical adsorbability to the phase-change alloy, they form a stronger protective film on the phase-change alloy surface. For this reason, excessive etching of the phase-change alloy after polishing with the polishing composition is suppressed, and excessive polishing of the phase-change alloy is suppressed.

The upper limit of the content of the metal corrosion inhibitor in the polishing composition is preferably 10% by mass, more preferably 5% by mass, further preferably 1% by mass. As the content of the metal corrosion inhibitor decreases, there is an effect of increasing the polishing rate of the phase-change alloy by the polishing composition.

The lower limit of the content of the metal corrosion inhibitor in the polishing composition is preferably 0.001% by mass, more preferably 0.01% by mass, further preferably 0.1% by mass. As the content of the metal corrosion inhibitor increases, excessive etching of the phase-change alloy after polishing with the polishing composition is suppressed, and excessive polishing of the phase-change alloy is suppressed.

A polishing pad can be used when the surface of an object containing a phase-change alloy is polished with the polishing composition of the present embodiment. Common nonwoven fabric, polyurethane foam, and a porous fluororesin can be used as the polishing pad without any particular limitation. Groove processing may be applied to the polishing pad so that the polishing composition can easily remain on the polishing pad.

The lower limit of the hardness of the polishing pad is preferably 50, more preferably 60, in terms of Shore D hardness. As the Shore D hardness of the pad increases, the mechanical action of the pad becomes large, and the polishing rate of the phase-change alloy increases. In addition, there is an advantage that high polishing rate of the phase-change alloy can be obtained also when the abrasive grains are not contained in the polishing composition.

The upper limit of the hardness of the polishing pad is preferably 99, more preferably 95, in terms of Shore D hardness. The lower the Shore D hardness of the pad, the more hardly a polished surface of the phase-change alloy is scratched. The Shore D hardness does not exceed 100 according to its definition. The Shore D hardness of the pad can be measured with a Shore D hardness meter.

A polishing pad having a Shore D hardness of 50 or more may be formed from a foam, or may be formed from a non-foamed article, such as a cloth and a nonwoven fabric. A resin can be used as a material of the polishing pad, such as polyurethane, acrylic, polyester, an acrylic-ester copolymer, polytetrafluoroethylene, polypropylene, polyethylene, poly(4-methylpentene), cellulose, cellulose ester, polyamide including nylon and aramid, polyimide, polyimideamide, a polysiloxane copolymer, an oxirane compound, a phenolic resin, polystyrene, polycarbonate, and an epoxy resin.

The present embodiment provides the following operation and advantages.
In the case where an object is polished with a conventional typical polishing composition used for polishing a metal-containing surface, a metal of the object is oxidized by the action of an oxidizing agent contained in the polishing composition to produce a metal oxide, and the metal oxide is dissolved by the action of a complexing agent also contained in the polishing composition, thereby to perform metal polishing. On the other hand, when a phase-change alloy is polished with the polishing composition of the present embodiment, ammonium ions contained in the polishing composition is complexed with and bound to the surface of the phase-change alloy to form an insoluble brittle film on the surface of the phase-change alloy. Therefore, the polishing composition of the present embodiment enables polishing the phase change-alloy at a high polishing rate.
When colloidal silica on which an organic acid is immobilized is added to the polishing composition, excellent dispersion stability is obtained over a long period of time. The reason is that colloidal silica on which an organic acid is immobilized tends to have a higher absolute value of the zeta potential in the polishing composition compared with common colloidal silica on which an organic acid is not immobilized. The electrostatic repulsive force between silica particles increases as the absolute value of the zeta potential in the polishing composition becomes large. Therefore, the aggregation of colloidal silica caused by the attraction of van der Waals force is harder to occur. For example, in an acidic pH range, colloidal silica on which an organic acid is immobilized generally has a negative zeta potential of −15 mV or less, while common colloidal silica has a zeta potential close to zero.

The above embodiment may be modified as follows.
The polishing composition of the above embodiment may optionally further contain known additives such as a surfactant, a water-soluble polymer, and a preservative.
The polishing composition of the above embodiment may be of a one-agent type or may be of a multi-agent type, such as a two-agent type.
The polishing composition of the above embodiment may be prepared by diluting a stock solution of the polishing composition with water.

Next, examples of the present invention and comparative examples will be described.

Polishing compositions of Examples 1 to 23 and Comparative Examples 1 to 26 having the formulation described in Tables 1 and 2 were prepared by suitably mixing abrasive grains, an ammonium ion source or an additive as a substitute therefor, and an oxidizing agent with water.

The “Content (% by mass)” columns of the “Abrasive grains” columns of Tables 1 and 2 show the content of abrasive grains in each of the polishing compositions. The notation of “-” in these columns represents that the polishing composition does not contain abrasive grains. The abrasive grains used in each of Examples 1 to 23 and Comparative Examples 1 to 26 were colloidal silica having an average primary particle size of 30 nm and an average secondary particle size of 60 nm.

The “Type” columns of the “Ammonium ion source or additive as a substitute therefor” columns of Tables 1 and 2 show the type of ammonium ion sources used in examples and the type of additives as a substitute for ammonium ion sources used in comparative examples. The additives used in comparative examples have been selected from complexing agents and corrosion inhibitors used in conventional typical polishing compositions for polishing metal-containing surfaces, and all the additives are compounds which do not act as an ammonium ion source. Further, the “Content (% by mass)” columns show the content of an ammonium ion source or an additive as a substitute therefor in each of the polishing compositions. The notation of “-” in these columns represents that the polishing composition does not contain an ammonium ion source or an additive as a substitute therefor.

The “Content (mol/L)” columns of the “Ammonium ion” columns of Tables 1 and 2 show the ammonium ion concentration, determined in terms of ammonia, in each of the polishing compositions.

The “Type” columns of the “Oxidizing agent” columns of Tables 1 and 2 show the type of an oxidizing agent contained in each of the polishing compositions. Further, the “Content (% by mass)” columns show the content of an oxidizing agent in each of the polishing compositions. The notation of “-” in these columns represents that the polishing composition does not contain an oxidizing agent.

The “pH” columns of Tables 1 and 2 show the pH of each of the polishing compositions. The pH of each of the polishing compositions was adjusted to a desired value by adding an inorganic acid or an inorganic base.

A blanket wafer containing a GST alloy (the mass ratio of Ge, Sb, and Te is 2:2:5) was polished under the conditions shown in Table 3 with each of the polishing compositions of Examples 1 to 23 and Comparative Examples 1 to 26. The thicknesses of each blanket wafer before and after polishing were determined from the measurement of sheet resistance by the direct current four-probe method, and the polishing rate was calculated by dividing the difference between the thicknesses of the wafer before polishing and after polishing by the polishing time. The values of the calculated polishing rate are shown in the “Polishing rate” columns of the “Evaluation” columns of Tables 1 and 2.

TABLE 1

| | Abrasive | Ammonium ion source or | | | | | | |
|---|---|---|---|---|---|---|---|---|
| | grains | additive as a substitute therefor | | Ammonium ion | Oxidizing agent | | | Evaluation |
| | Content (% | | Content (% | Concentration | | Content (% | | Polishing rate |
| | by mass) | Type | by mass) | (mol/L) | Type | by mass) | pH | (Å/min) |
| Example 1 | 10 | Ammonium | 0.5 | 0.14 | — | — | 3 | 95 |
| | | hydroxide | | | | | | |
| Example 2 | 10 | Ammonium | 0.5 | 0.14 | — | — | 7 | 78 |
| | | hydroxide | | | | | | |
| Example 3 | 10 | Ammonium | 0.5 | 0.14 | — | — | 10 | 104 |
| | | hydroxide | | | | | | |
| Example 4 | 10 | Ammonium | 0.5 | 0.14 | Hydrogen peroxide | 0.7 | 10 | 139 |
| | | hydroxide | | | | | | |
| Example 5 | 10 | Ammonium | 0.06 | 0.06 | Hydrogen peroxide | 0.7 | 10 | 130 |
| | | hydroxide | | | | | | |
| Example 6 | 2.5 | Ammonium | 0.5 | 0.14 | Hydrogen peroxide | 2.1 | 10 | 139 |
| | | hydroxide | | | | | | |
| Example 7 | 0.5 | Ammonium | 0.5 | 0.14 | Hydrogen peroxide | 0.7 | 10 | 43 |
| | | hydroxide | | | | | | |
| Example 8 | — | Ammonium | 0.5 | 0.14 | — | — | 10 | 26 |
| | | hydroxide | | | | | | |
| Example 9 | 2.5 | Ammonium | 0.5 | 0.14 | Hydrogen peroxide | 0.2 | 3 | 64 |
| | | hydroxide | | | | | | |
| Example 10 | 2.5 | Ammonium | 0.5 | 0.14 | Periodic acid | 1.1 | 3 | 592 |
| | | hydroxide | | | | | | |
| Example 11 | 2.5 | Ammonium | 0.5 | 0.14 | Periodic acid | 1.1 | 10 | 353 |
| | | hydroxide | | | | | | |
| Example 12 | 2.5 | Ammonium | 0.5 | 0.14 | 2KHSO₅•KHSO₄•K₂SO₄ | 3.1 | 3 | 598 |
| | | hydroxide | | | | | | |
| Example 13 | 2.5 | Ammonium | 0.5 | 0.14 | Hypochlorous acid | 0.5 | 10 | 321 |
| | | hydroxide | | | | | | |
| Example 14 | 2.5 | Ammonium | 0.5 | 0.14 | Hypochlorous acid | 0.5 | 3 | 473 |
| | | hydroxide | | | | | | |
| Example 15 | 2.5 | Ammonium | 0.5 | 0.14 | Na hypochlorite | 0.5 | 10 | 63 |
| | | hydroxide | | | | | | |
| Example 16 | 2.5 | Ammonium | 0.5 | 0.14 | Na hypochlorite | 0.5 | 3 | 51 |
| | | hydroxide | | | | | | |
| Example 17 | 2.5 | Ammonium | 0.5 | 0.14 | Ammonium peroxodisulfate | 1.1 | 10 | 252 |
| | | hydroxide | | | | | | |
| Example 18 | 2.5 | Ammonium | 0.5 | 0.14 | Ammonium peroxodisulfate | 1.1 | 3 | 113 |
| | | hydroxide | | | | | | |
| Example 19 | 2.5 | Ammonium | 0.5 | 0.14 | Nitric acid | 0.3 | 10 | 45 |
| | | hydroxide | | | | | | |
| Example 20 | 2.5 | Ammonium | 0.5 | 0.14 | Nitric acid | 0.3 | 3 | 32 |
| | | hydroxide | | | | | | |
| Example 21 | 2.5 | Ammonium | 0.5 | 0.14 | Nitrous acid | 0.2 | 10 | 51 |
| | | hydroxide | | | | | | |
| Example 22 | 2.5 | Ammonium | 0.5 | 0.14 | Nitrous acid | 0.2 | 3 | 38 |
| | | hydroxide | | | | | | |
| Example 23 | 2.5 | Ammonium | 0.5 | 0.14 | Iron nitrate (III) | 1.2 | 2 | 451 |
| | | hydroxide | | | | | | |

TABLE 2

| | Abrasive | Ammonium ion source or | | | | | | |
|---|---|---|---|---|---|---|---|---|
| | grains | additive as a substitute therefor | | Ammonium ion | Oxidizing agent | | | Evaluation |
| | Content (% | | Content (% by | Concentration | | Content (% | | Polishing rate |
| | by mass) | Type | mass) | (mol/L) | Type | by mass) | pH | (Å/min) |
| Comparative | — | — | — | — | — | — | 3 | 13 |
| Example 1 | | | | | | | | |
| Comparative | 0.5 | — | — | — | — | — | 3 | 15 |
| Example 2 | | | | | | | | |
| Comparative | 0.5 | Thiourea | 0.08 | 0 | — | — | 3 | 21 |
| Example 3 | | | | | | | | |
| Comparative | 0.5 | Acetoacetamide | 0.1 | 0 | — | — | 3 | 4 |
| Example 4 | | | | | | | | |
| Comparative | 0.5 | N,N- | 0.13 | 0 | — | — | 3 | 11 |
| Example 5 | | dimethylacetoacetamide | | | | | | |
| Comparative | 0.5 | N,N-dimethyl-2- | 0.13 | 0 | — | — | 3 | 9 |
| Example 6 | | chloroacetoacetamide | | | | | | |
| Comparative | 0.5 | Polyvinylpyrrolidone | 0.1 | 0 | — | — | 3 | 9 |
| Example 7 | | | | | | | | |
| Comparative | 0.5 | Polyacrylamide | 0.1 | 0 | — | — | 3 | 12 |
| Example 8 | | | | | | | | |
| Comparative | 0.5 | Polyacrylic acid | 0.1 | 0 | — | — | 3 | 14 |
| Example 9 | | | | | | | | |
| Comparative | — | Dicyandiamide | 0.1 | 0 | — | — | 3 | 9 |
| Example 10 | | diethylenetriamine | | | | | | |
| Comparative | 10 | — | — | — | — | — | 10 | 17 |
| Example 11 | | | | | | | | |
| Comparative | 2.5 | — | — | — | — | — | 3 | 4 |
| Example 12 | | | | | | | | |
| Comparative | 2.5 | — | — | — | — | — | 10 | 8 |
| Example 13 | | | | | | | | |
| Comparative | 2.5 | — | — | — | Hydrogen peroxide | 0.2 | 10 | 16 |
| Example 14 | | | | | | | | |
| Comparative | 2.5 | — | — | — | Hydrogen peroxide | 0.2 | 3 | 13 |
| Example 15 | | | | | | | | |
| Comparative | 2.5 | — | — | — | Periodic acid | 1.1 | 10 | 23 |
| Example 16 | | | | | | | | |
| Comparative | 2.5 | — | — | — | Periodic acid | 1.1 | 3 | 31 |
| Example 17 | | | | | | | | |
| Comparative | 2.5 | — | — | — | 2KHSO₅•KHSO₄•K₂SO₄ | 3.1 | 3 | 38 |
| Example 18 | | | | | | | | |
| Comparative | 2.5 | — | — | — | Hypochlorous acid | 0.5 | 10 | 36 |
| Example 19 | | | | | | | | |
| Comparative | 2.5 | — | — | — | Hypochlorous acid | 0.5 | 3 | 53 |
| Example 20 | | | | | | | | |
| Comparative | 2.5 | — | — | — | Na hypochlorite | 0.5 | 10 | 28 |
| Example 21 | | | | | | | | |
| Comparative | 2.5 | — | — | — | Na hypochlorite | 0.5 | 3 | 23 |
| Example 22 | | | | | | | | |
| Comparative | 2.5 | — | — | — | Nitric acid | 0.3 | 10 | 20 |
| Example 23 | | | | | | | | |
| Comparative | 2.5 | — | — | — | Nitric acid | 0.3 | 3 | 14 |
| Example 24 | | | | | | | | |
| Comparative | 2.5 | — | — | — | Nitrous acid | 0.2 | 10 | 23 |
| Example 25 | | | | | | | | |
| Comparative | 2.5 | — | — | — | Nitrous acid | 0.2 | 3 | 17 |
| Example 26 | | | | | | | | |

TABLE 3

Polisher: One-side CMP polishing apparatus
Polishing pad: Polishing pad made of polyurethane
Polishing pressure: 1.2 psi (≈85 hPa)
Rotational speed of platen: 60 rpm
Polishing composition: Used with continuously
fed without being circulated
Rotational speed of carrier: 60 rpm

As shown in Tables 1 and 2, the polishing compositions of Examples 1 to 3, each of which contains abrasive grains and ammonium ions, were verified to have a higher polishing rate compared with the polishing compositions of Comparative Examples 2 and 11 to 13, each of which contains only abrasive grains, and the polishing compositions of Comparative Examples 3 to 9, each of which contains abrasive grains and the additives that cannot act as an ammonium ion source. The polishing composition of Example 8, which contains ammonium ions, was verified to have a higher polishing rate compared with the polishing composition of Comparative Example 1, which consists only of water, and the polishing composition of Comparative Example 10, which contains only the additive that cannot act as an ammonium ion source. The polishing compositions of Examples 4 to 7 and 9, each of which contains abrasive grains, ammonium ions, and hydrogen peroxide, were verified to have a higher polishing rate compared with the polishing compositions of Comparative Examples 14 to 16, each of which contains abrasive grains and hydrogen peroxide. The polishing compositions of Examples 10 to 23, each of which contains abrasive grains, ammonium ions, and an oxidizing agent, were verified to have a higher polishing rate compared with the polishing compositions of Comparative Examples 17 to 26, each of which contains abrasive grains and the same oxidizing agents as in the examples. That is, it was verified that in the case where the polishing compositions of Examples 1 to 23 were used, the polishing rate increased as compared with the case where the polishing compositions of Comparative Examples 1 to 26, which do not belong to the scope of the present invention, were used.

1. A polishing composition to be used for polishing an object containing a phase-change alloy, comprising ammonium ions (NH₄⁺).

2. The polishing composition according to claim 1, wherein as the ammonium ions, ammonium hydroxide is incorporated into the polishing composition.

3. The polishing composition according to claim 1, wherein as the ammonium ions, one or more ammonium salts selected from the group consisting of an ammonium salt of an organic acid and an ammonium salt of an inorganic acid are incorporated into the polishing composition.

4. The polishing composition according to claim 1, further comprising abrasive grains.

5. The polishing composition according to claim 4, wherein the abrasive grains are colloidal silica.

6. The polishing composition according to claim 1, wherein the phase-change alloy is a germanium-antimony-tellurium alloy.

7. A polishing method comprising:
providing an object containing a phase-change alloy; and
using the polishing composition according to claim 1 to polish a surface of the object.

8. A method for producing a phase-change device, comprising polishing a surface of an object containing a phase-change alloy with the polishing composition according to claim 1.

9. The polishing composition according to claim 2, further comprising abrasive grains.

10. The polishing composition according to claim 3, further comprising abrasive grains.

11. The polishing composition according to claim 9, wherein the abrasive grains are colloidal silica.

12. The polishing composition according to claim 10, wherein the abrasive grains are colloidal silica.

13. The polishing method according to claim 7, wherein the phase-change alloy is a germanium-antimony-tellurium alloy.

14. The polishing method according to claim 7, further comprising adding abrasive grains to the polishing composition prior to said using.

15. The polishing method according to claim 14, wherein the abrasive grains are colloidal silica.

16. The polishing method according to claim 13, further comprising adding colloidal silica to the polishing composition prior to said using.

17. The method according to claim 8, wherein the phase-change alloy is a germanium-antimony-tellurium alloy.

18. The method according to claim 8, further comprising adding abrasive grains to the polishing composition prior to said polishing.

19. The method according to claim 18, wherein the abrasive grains are colloidal silica.

20. The method according to claim 17, further comprising adding colloidal silica to the polishing composition prior to said polishing.
